(19) United States
(12) Patent Application Publication
(10) Pub. No.: US 2005/0108911 A1
(43) Pub. Date: May 26, 2005

(54) Flip-open floor sign

(75) Inventors: Thomas Perelli, Winchester, VA (US); Owen Alan Slater, Winchester, VA (US); Carl R. Schulz, Winchester, VA (US); Shawn M. Squires, Winchester, VA (US)

Correspondence Address: FOLEY AND LARDNER;SUITE 500, 3000 K STREET NW, WASHINGTON, DC, 20007, US

(73) Assignee: Rubbermaid Commercial Products LLC

(21) Appl. No.: 10/970,719

(22) Filed: Oct. 22, 2004

Related U.S. Application Data
(60) Provisional application No. 60/513,206, filed on Oct. 23, 2003.

(51) Int. Cl. G09F 15/00

(52) U.S. Cl. 40/610

(57) ABSTRACT

A flip-open floor sign includes a display panel, a first foot, and a second foot. The first foot and second foot are each connected to a lower portion of the display panel by a connecting mechanism. The first foot and second foot are configured to move between a closed position and an open position, and are configured to pivot relative to the display panel.

### CROSS-REFERENCE TO RELATED PATENT APPLICATIONS

This application claims priority to U.S. Application Ser. No. 60/513,206, filed Oct. 23, 2003.

### BACKGROUND OF THE INVENTION

The present invention relates to signs.

Conventionally, buildings, cleaning crews, and companies use signs to warn people about hazards, such as slippery floors. Such conventional signs may be prone to collapsing and falling over.

A typical sign may be constructed of a traditional A-frame or sandwich board configuration. Such a sign is less stable than desired, as it can fold and collapse easily when bumped. Additionally, when an A-frame sign collapses, the two primary members of the sign's frame can slap together and make a large clapping noise. This loud noise can be alarming and a nuisance to people near the sign.

Another drawback of such a conventional sign is that a person can be injured when incorrectly picking up the sign when the sign is in the standing position. The two primary members forming the A-frame collapse together when the sign is picked up, and the fingers of the person picking up the sign can be pinched between the collapsing members.

A-frame signs have been developed that have additional supports, such as in U.S. Pat. Nos. 4,928,415 and 6,131,320 (incorporated herein by reference in their entirety). Such a conventional sign includes cross braces connecting the two members of the A-frame. The cross braces can increase the stability of the sign. A drawback of such a configuration, however, is that the cross braces add additional steps to set up and collapse the sign and, thus, the cross-braced A-frame is not easy to use.

Another conventional sign is a three or four-sided cone. The three or four-sided cone sign can be more stable than the A-frame sign, but the cone is a bulky sign that is unable to fold into a slim profile. For example, the cone cannot be folded for compact storage or transport.

### SUMMARY OF THE INVENTION

According to an aspect of the invention, a sign is provided. The sign comprises a display panel, a first foot, a second foot, and a connecting mechanism that connects the first foot and second foot to a lower portion of the display panel. The first foot and second foot are configured to move between a closed position and an open position. When in the open position, the first foot and second foot are configured to be substantially parallel to a surface upon which the first foot and second foot rest.

According to another aspect of the invention, a sign is provided. The sign comprises a display panel, a first foot, a second foot, and a connecting mechanism. The connecting mechanism connects the first foot and second foot to a lower portion of the display panel. The first foot and second foot are configured to move between a closed position and an open position. When in the closed position, the first foot is configured to be adjacent and substantially parallel to the display panel, and the second foot is configured to be extending below and substantially parallel to the display panel.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a perspective view of a sign according to a first embodiment of the invention.

FIG. 2 is a side view of the sign according to FIG. 1.

FIG. 3 is a perspective view of the sign according to FIG. 1 in the open position.

FIG. 4 is a perspective view of the display panel according to FIG. 1.

FIG. 5 is a perspective view of a foot of the sign according to FIG. 1.

FIG. 6 is a perspective view of the feet of the sign in the closed position.

FIG. 7 is a perspective view of the feet moving toward the open position.

FIG. 8 is a perspective view of the sign in the open position.

FIG. 9 is a perspective view of a sign according to a second embodiment of the present invention.

FIG. 10 is a perspective view of the integral feet according to FIG. 9.

FIG. 11 is a front view of the display panel according to FIG. 9.

FIG. 12 is a cross-sectional view along A-A of the sign according to FIG. 9 in the closed position

FIG. 13 is a cross-sectional view along A-A of the sign according to FIG. 9 in the open position.

### DETAILED DESCRIPTION OF THE PREFERRED EMBODIMENTS

Reference will now be made in detail to preferred embodiments of the invention, examples of which are illustrated in the accompanying drawings. An effort has been made to use the same reference numbers throughout the drawings to refer to the same or like parts.

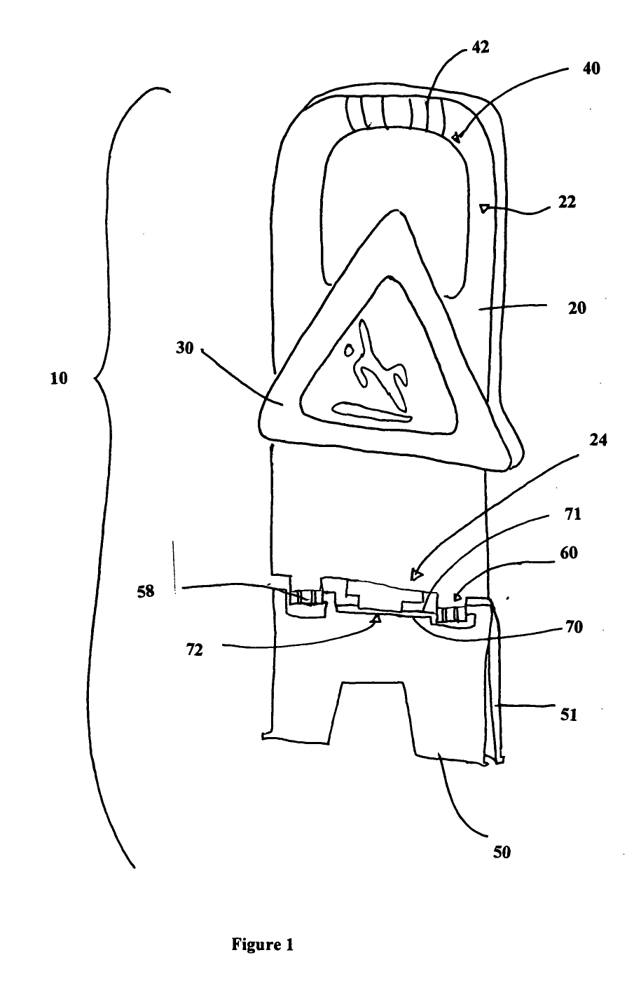

According to a first embodiment of the invention, as shown in FIGS. 1-8, a flip-open floor sign 10 includes a display panel 20, a first foot 50, a second foot 51, and a connecting mechanism 60.

The display panel 20 can include a single panel, with an upper portion 22 and a lower portion 24. The display panel 20 preferably is configured to be substantially perpendicular to a surface 5 when the sign 10 is in the in-use position.

The display panel 20 further includes a sign portion 30 that can provide a warning or caution notice. The sign portion 30 can be molded integrally with the display panel 20. The sign portion 30 may be on either side or both sides of the display panel 20 and creates a sign surface that is easily visible to persons near the sign 10. The sign portion 30 may be a triangular shape, or any other suitable shape.

The sign portion 30 may include a warning such as, for example, a visual warning of a slippery floor that includes a symbol of a person falling. The visual warning may be repeated on both sides of the display panel 20. When the visual warning is repeated, the visual warning or image on one side of the display panel 20 can be the inverse of the visual warning on the other side of the display panel 20, thus preventing a shadow effect. A shadow effect can occur when the display panel 20 has two distinct images on each side. In bright light, due to the translucent nature of the display panel 20, a passerby may see both the image on the first side, as well as the image on the second side. This shadow effect creates a confusing image. Therefore, the sign 10 may have inverse images that prevent this shadow effect. The sign portion 30 also can include only visual images without words, which makes the sign 10 appealing to a multicultural or international audience.

The display panel 20 may also include a handle portion 40 positioned in the upper portion 22 of the display panel 20, above the sign portion 30. The handle portion 40, as shown in FIG. 1, may be integrally formed with the display panel 20. The handle portion 40 may include a grip portion 42 for gripping or holding the sign 10. The handle portion 40 is displaced from the feet 50 and 51, which prevents a person's fingers from being pinched when picking up the sign.

The sign 10 preferably includes two feet, namely the first foot 50 and the second foot 51. The first foot 50 and the second foot 51 can be connected to the lower portion 24 of the display panel 20. Preferably, they are connected to the bottom of the display panel 20. The first foot 50 and second foot 51 may be substantially identical.

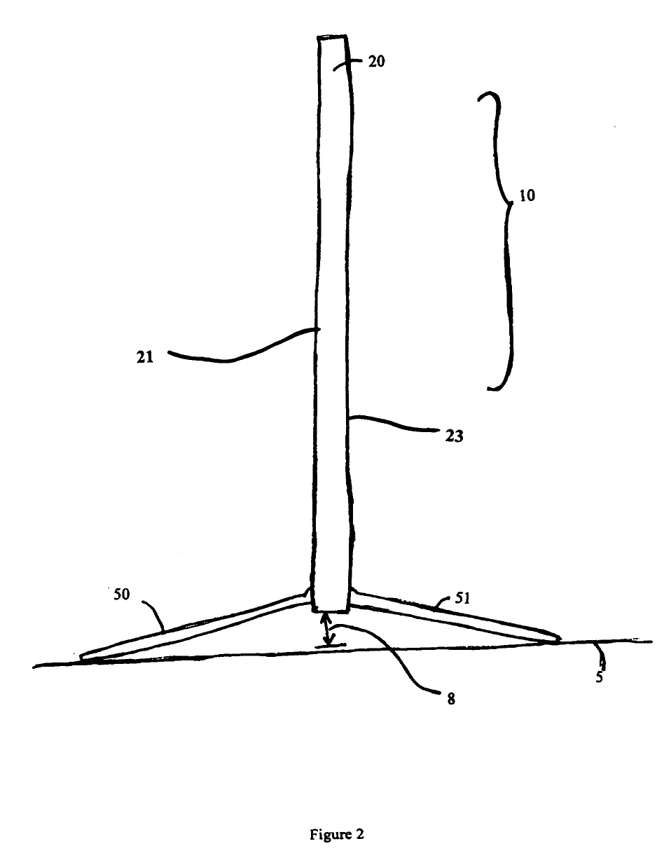

The first foot 50 and second foot 51 are configured to move between a closed, storage position, and an open, in-use position as shown in FIGS. 1 and 2, respectively. The first foot 50 and second foot 51 can move, for example, by pivoting relative to the display panel 20.

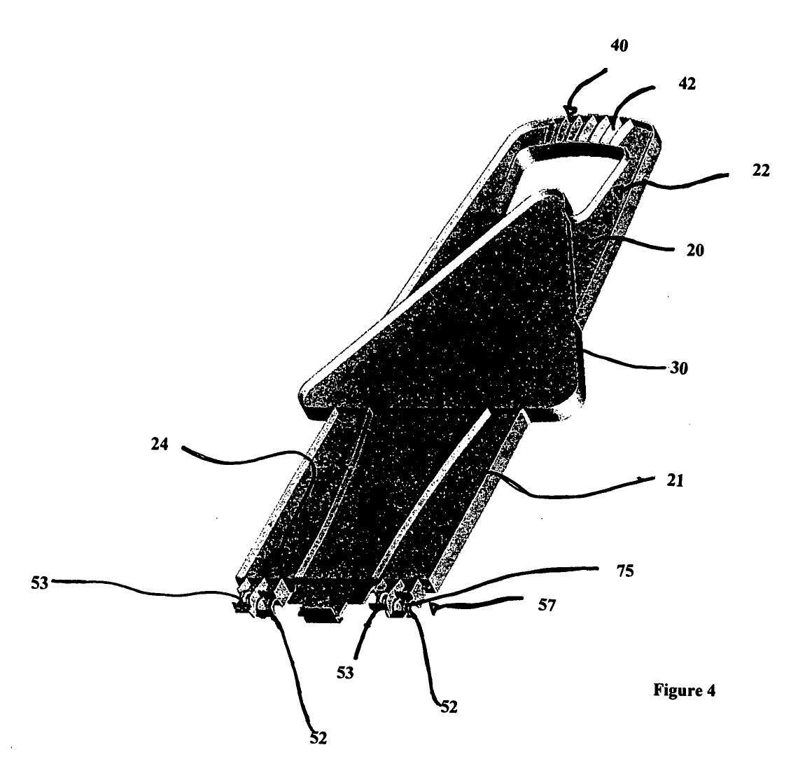

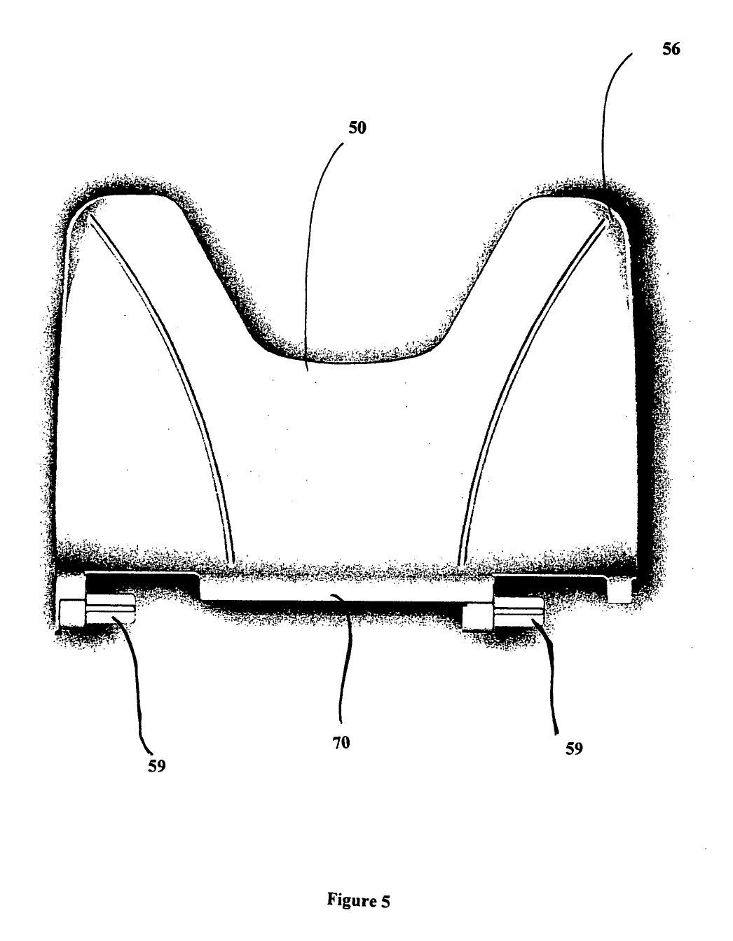

A connecting mechanism 60 connects each foot 50, 51 to the display panel 20. The connecting mechanism 60 may be a hinge 58, or any other suitable connecting device. The display panel 20 includes an attachment portion 57 extending below the lower portion 24 of the display panel 20 as part of the connecting mechanism 60. Preferably, the display panel 20 includes two attachment portions 57. Each attachment portion 57 comprises a receiving portion 75 that extends downward and has an opening through which a pin 59 or rod may be inserted, as shown in FIG. 4. Preferably, each foot 50, 51 includes two pins 59 as an integral, molded part of each foot 50, 51. A pin 59 is positioned at each end of each foot 50, 51, and at the portion proximate the lower portion 24 of the display panel 20, as shown in FIG. 5. Each pin 59 of the first foot 50 is inserted through the attachment portions 57 of the display panel 20 to connect the first foot 50 to the display panel 20. The second foot 51 is connected to the display panel 20 in a similar manner. The pin 59 may also be a separate part and not integral with a foot 50, 51.

Each attachment portion 57 is capable of receiving a pin 59 from each foot 50, 51. The attachment portion 57 has a first portion 52 capable of receiving a pin 59 from the first foot 50 and a second portion 53 capable of receiving a pin from the second foot 51. The first portion 52 is positioned on the bottom of the display panel 20, proximate the front face 21 of the display panel 20, whereas the second portion 53 is positioned on the bottom of the display panel 20, proximate the rear face 23 of the display panel 20. This configuration prevents the connection of the first foot 50 to the display panel 20 from interfering with the connecting of the second foot 51 to the display panel 20.

The hinge 58 may be positioned adjacent the display panel 20 such that the first foot 50 and the second foot 51 can pivot to a closed position without adding additional thickness to the sign 10, as seen in FIG. 1. The hinge 58 is positioned below the display panel 20 and remains in such a position when the first foot 50 and the second foot 51 pivot to a closed position. The hinge 58 allows for more compact storage when the sign 10 is in the closed position.

The first foot 50 and second foot 51 pivot between an open and closed position. In the closed position, the first foot 50 and the second foot 51 are configured to be substantially parallel to the display panel 20, as shown in FIG. 1. The first foot 50 and second foot 51 extend downward from the lower portion 24 of the display panel 20 when in the closed position. This configuration allows the sign 10 to be compactly stored.

In the open position, the first foot 50 and second foot 51 are configured to be substantially parallel to the surface 5 upon which they rest, as shown in FIG. 2. Because the first foot 50 and second foot 51 are substantially parallel to the surface 5 when the sign 10 is open and in use, the sign 10 is more stable. The sign 10 is more stable because substantially the entirety of the first foot 50 and the second foot 51 are proximate to the surface 5 upon which the sign 10 rests and this proximity gives the sign 10 a lower center of gravity.

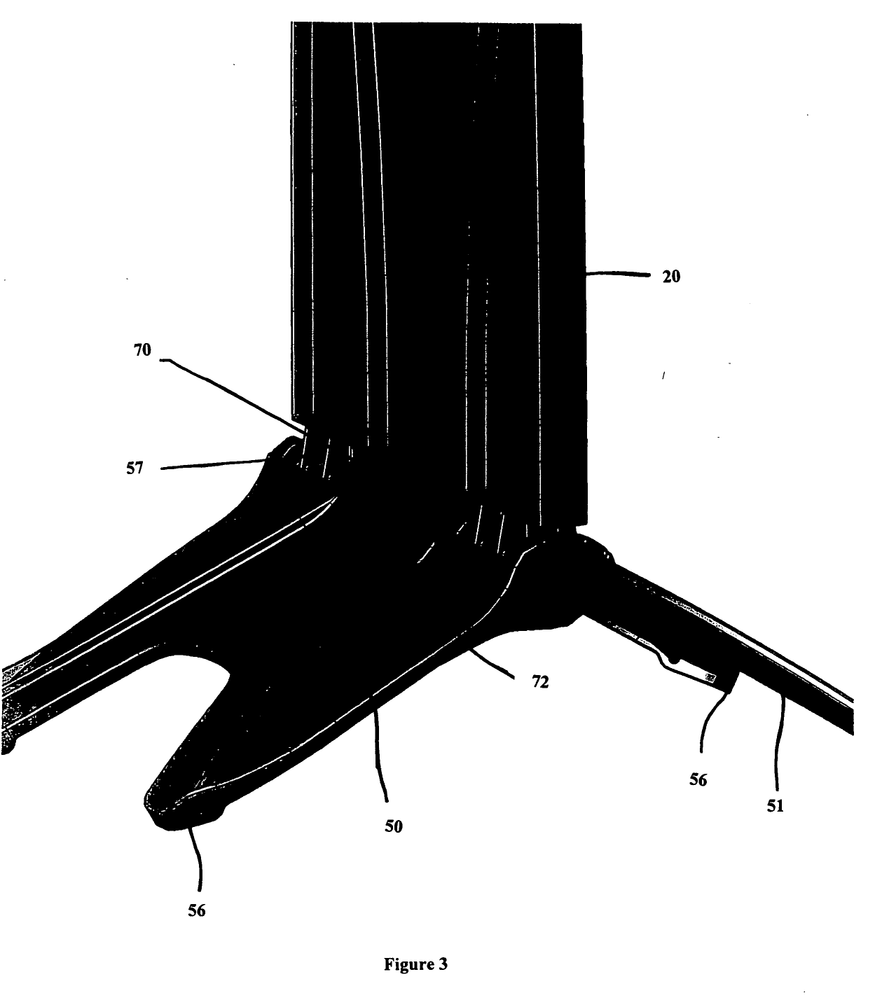

The portion of the first foot 50 and second foot 51 proximate the display panel 20 are preferably raised off the surface 5 slightly when in the open position. Preferably, the first foot 50 and the second foot 51 create an inverted V-shape, as shown in FIGS. 2 and 3. This inverted V-shape provides a slight clearance 8, which can be, for example ⅛ inch. The inverted V-shape is significant because it ensures that the sign 20 rests on the surface 5 near the outer corner 56 of the feet 50, 51. This V-shape configuration serves to maximize the stability of the sign 20 by holding the contact points between the feet 50, 51 and the surface 5 as far away from the center of the display panel 20 as possible.

The display panel 20 maintains an upright position, generally perpendicular to the surface 5, when in the open position by the configuration of the feet 50, 51. The feet 50, 51 apply equal and opposite moments on the lower portion 24 of the display panel 20. This is effected by a contact between an edge 70, 71 of each foot 50, 51, respectively and the lower portion 24 of the display panel 20. The contact points 72 at the edges 70, 71 are offset from the respective pivots of the hinges 58 for feet 50, 51. The contact points 72 are offset such that they are spaced apart on the edge 70, 71 from the hinge 58.

The feet 50, 51 are configured to remain open, even when the sign 10 is bumped, knocked, or when a force is applied to a sign 10, thus preventing the sign 10 from falling over. The sign 10 will not fall over easily, compared to conventional signs, because the first foot 50 and the second foot 51 are substantially parallel and proximate the surface 5. The sign 10 instead will slide across the surface 5 when bumped.

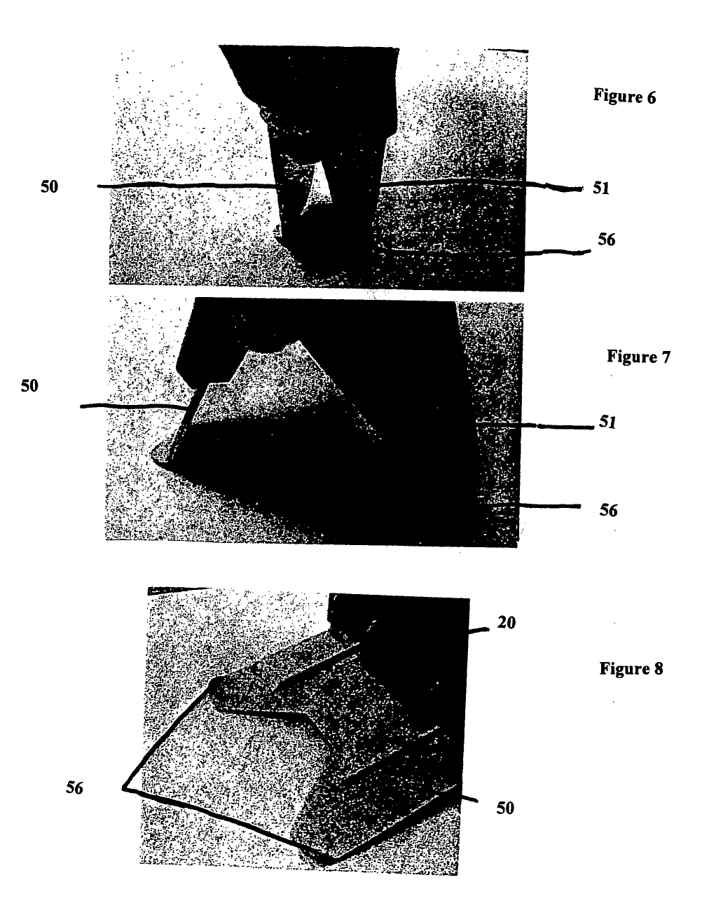

To open the sign 10, a user pushes the sign 10 against the surface 5. The first foot 50 and the second foot 51 are placed against the surface 5 and are originally in the closed position, as shown in FIG. 6. As the feet 50, 51 are pushed against the surface 5, the feet 50, 51 begin to separate and spread apart from each other, as shown in FIG. 7. As the user continues to push the sign 10 against the surface 5, the first foot 50 and the second foot 51 spread apart and come to the open position. In the open position, the feet 50, 51 are substantially parallel to the surface 5, as shown in FIG. 8.

The first foot 50 and second foot 51 may include one or more flared portions 56, as shown in FIGS. 6 and 7 that assist in spreading the feet 50, 51. The flared portion 56 is a section of a foot 50, 51, at an end distal to the lower portion 24 of the display panel 20, which flares upward at an angle away from the plane of the foot 50, 51. When a user pushes down on the sign 10, the flared portions 56 force the first foot 50 away from the second foot 51, and therefore, positions the feet 50 and 51 in the open position.

To close the sign 10, a user merely lifts the sign 10 off the surface 5. The first foot 50 and second foot 51 are configured to automatically move into the closed position, as shown in FIG. 3. In particular, the connecting mechanism 58 can be configured to permit the force of gravity to move the feet 50 and 51 to the closed position as the sign 10 is lifted off the surface 5.

The sign 10 may be made of plastic, or any other suitable material. The sign 10 may be formed by a thermoplastic molding process. A thermosetting forming plastic, an injection molding process, vacuum forming plastic, or any other suitable method may be used to make the sign 10.

One advantage of the sign 10 is that it requires less material than conventional A-frame signs. Furthermore, the first foot 50 and second foot 51 are substantially identical, which results in cost-effective efficiencies in the manufacturing of the sign 10, as well as decreasing the inventory of spare parts, and limiting scrap. In addition, the sign 10 utilizes three functional pieces: a display panel 20, and substantially identical first foot 50 and second foot 51. The three functional pieces form a sign 10 that is less complex to assemble compared to conventional A-frame signs.

The configuration of the sign 10 inhibits the collapse of the sign 10. The sign 10 is more stable and has a lower center of gravity compared to conventional signs. Furthermore, if the sign 10 does happen to fall or collapse, the sign 10 will not make a loud clapping noise as two panels slap together, such as the noise a conventional A-frame sign will make.

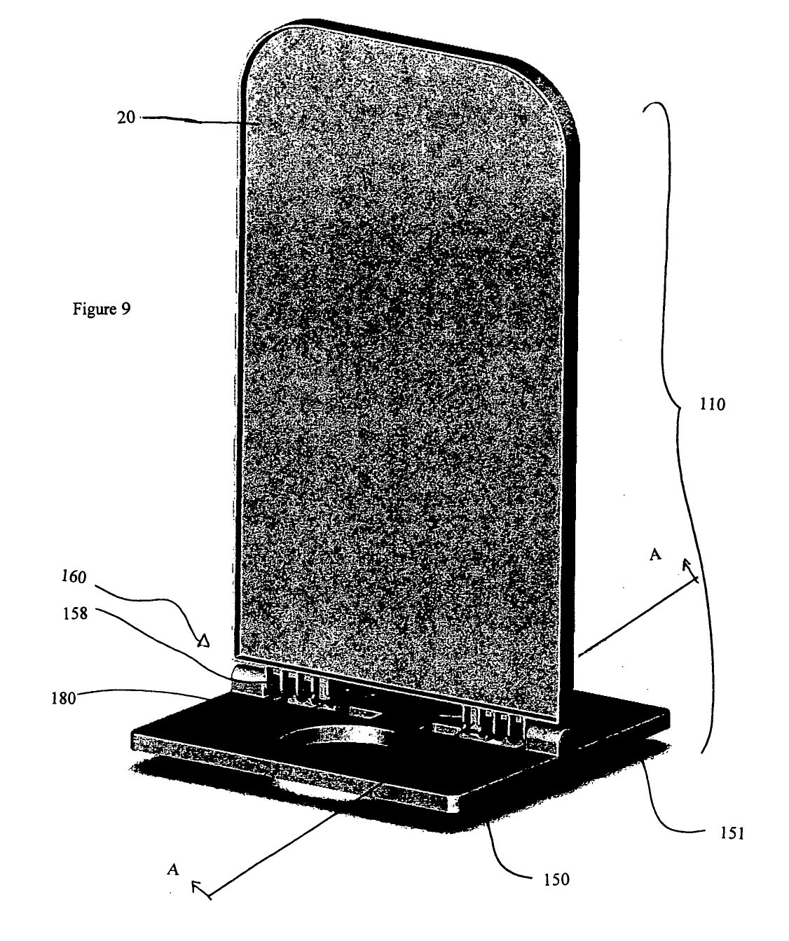

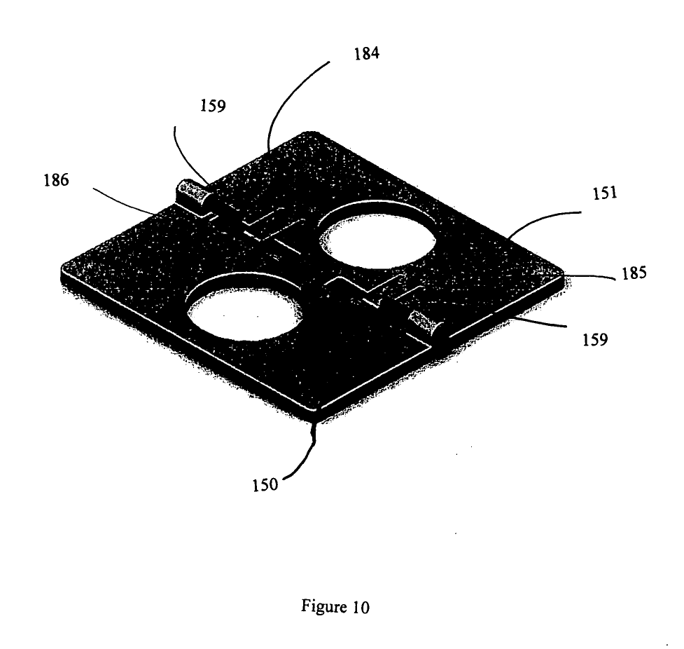

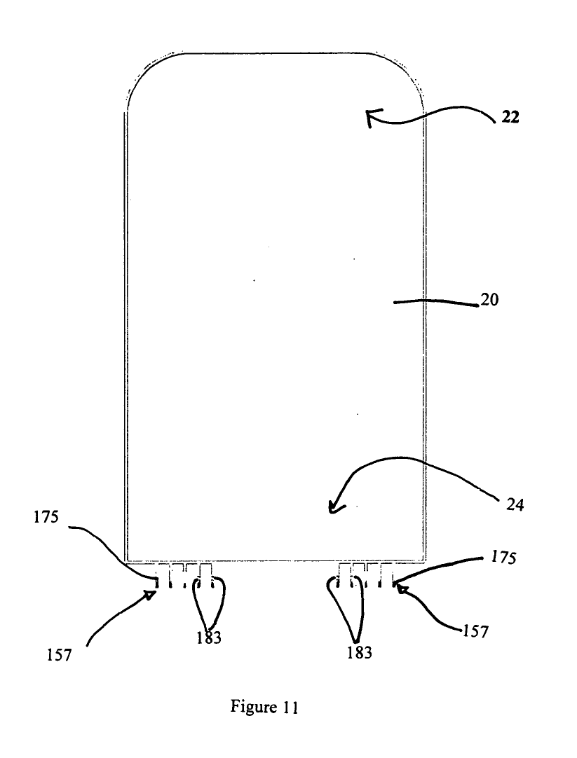

According to a second embodiment of the present invention, as shown in FIGS. 9-13, a sign 110 includes a display panel 20, a first foot 150, a second foot 151, and a connecting mechanism 160.

The display panel 20 can be the same as or similar to the display panel of the first embodiment. It also may include a handle portion 40.

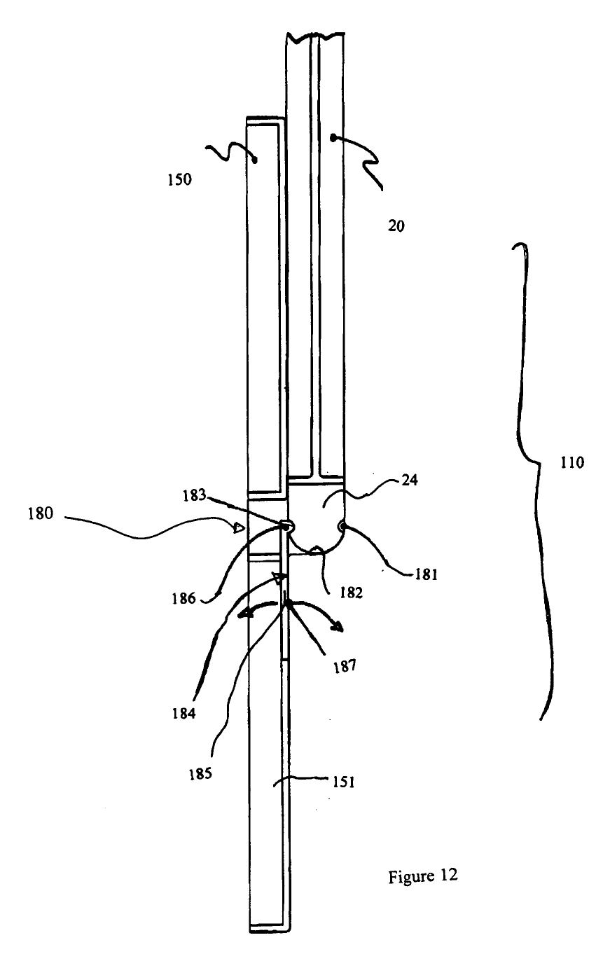

In this second embodiment, the first foot 150 and the second foot 151 are fixed in position relative to one another and preferably are integrally formed. The first foot 150 and second foot 151 pivot relative to the display panel 20 between an open and closed position. In the closed position, the first foot 150 is positioned adjacent to and substantially parallel with the display panel 20, as shown in FIG. 12. The second foot 151 is configured to extend below and substantially parallel with the display panel 20 in the closed position. This configuration allows the sign 110 to be compactly stored.

The connecting mechanism 160 may comprise a hinge 158. The hinge 158 includes an attachment portion 157 extending below and integral with the lower portion 24 of the display panel 20. Preferably, the display panel 20 includes two attachment portions 157, one at each end of the lower portion 24 of the display panel 20. The attachment portions 157 comprise receiving portions 175 that extend downward and have an opening configured to receive a pin 159. The integral foot 150, 151 includes preferably two pins 159, positioned opposite each other and proximate the lower portion 24 of the display panel 20. Each pin 159 is inserted through the attachment portion 157 to connect the integral feet 150, 151 to the display panel 20.

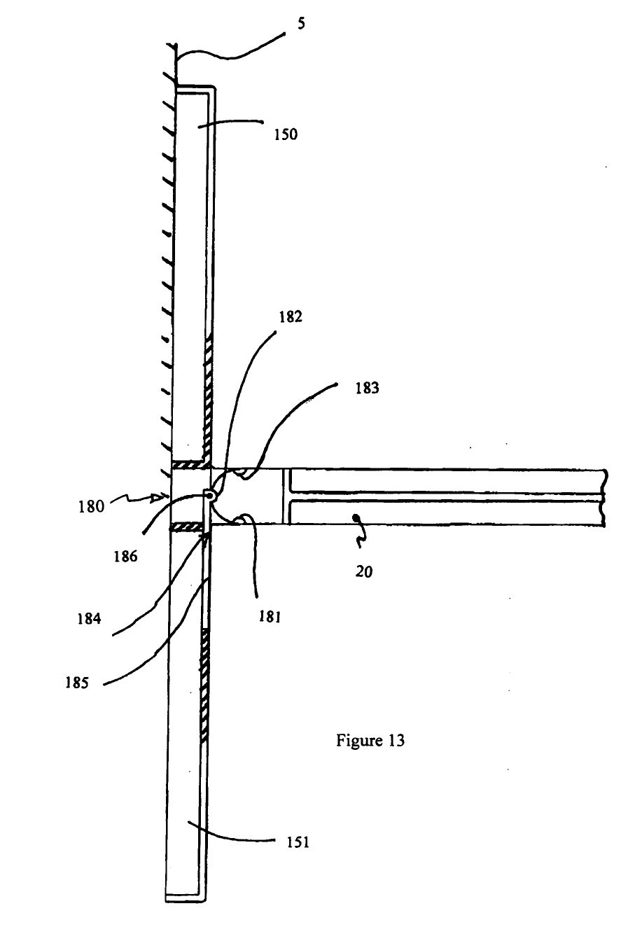

The sign 110 maintains an upright position, generally perpendicular to the surface 5, by a locking unit 180. The locking unit 180 comprises a recess 182 and a tab 184, shown in FIGS. 12 and 13. The tab includes a base 185 and a protruding portion 186. The recess 182 is positioned in the lower portion 24 of the display panel 20. The tab 184 protrudes from the integral feet 150, 151 and is configured to fit into the recess 182. Preferably, the display panel 20 includes three recesses, an open-position recess 182 and two closed-position recesses 181 and 183. The open-position recess 182 is positioned on the bottom of the lower portion 24 of the display panel 20. The closed-position recesses 181 and 183 are positioned on opposed sides of the lower portion 24 of the display panel 20. When the protruding portion 186 fits into the open-position recess 182, the sign 110 is positioned in the upright, in-use configuration. When the protruding portion 186 fits into either of the closed-position recesses 181 or 183, the sign 110 is positioned in the closed, storage position.

The base 185 is a flexible member that will bend up or down to lock or release the display panel 20. When the display panel 20 is adjusted from an open to a closed configuration, the base 185 bends out of the open-position recess 182. The base 185 is not hinged mechanically. Rather, the base 185 bends at a bending point 187 of the plastic material, without deformation. As can be seen from the arrows in FIG. 12, the base 185 can bend in either direction at the bending point 187.

In the open position, the first foot 150 and second foot 151 are substantially parallel to the surface 5 upon which the first foot 150 and the second foot 151 rest, as shown in FIG. 13. This configuration can provide stability benefits similar to the first embodiment.

The sign 110 of the second embodiment can be opened through one-handed deployment. A user pushes the sign 110 against a surface 5 to move the first foot 150 and the second foot 151 into the open position. As the first foot 150 or second foot 151 is pushed against the surface 5, the first foot 150 and second foot 151 pivot into the open position, allowing for a one-handed deployment by a user.

The embodiments described above have been set forth herein for the purpose of illustration. This description, however, should not be deemed to be a limitation on the scope of the invention. Various modifications, adaptations, and alternatives may occur to one skilled in the art without departing from the claimed inventive concept. The scope and spirit of the invention are indicated by the following claims.

1. A sign, comprising:
a display panel;
a first foot;
a second foot; and
a connecting mechanism that connects the first foot and second foot to a lower portion of the display panel,
wherein the first foot and second foot are configured to move between a closed position and an open position, and
wherein, when in the open position, the first foot and second foot are configured to be substantially parallel to a surface upon which the first foot and second foot rest.

2. The sign of claim 1, wherein the first foot and second foot are configured to remain in the open position when a force is applied to the sign.

3. The sign of claim 1, wherein the first foot and second foot are substantially identical.

4. The sign of claim 1, wherein the first foot and second foot are configured to pivot relative to the display panel.

5. The sign of claim 1, wherein the connecting mechanism comprises a hinge.

6. The sign of claim 1, wherein the connecting mechanism is configured such that the first foot and second foot are substantially parallel to the display panel in the closed position.

7. The sign of claim 1, wherein the first foot and second foot extend downward from the lower portion of the display panel in the closed position.

8. The sign of claim 1, wherein the first foot and second foot are configured to move from the closed position toward the open position when the first foot and second foot are pushed against a surface.

9. The sign of claim 1, further comprising a handle integral with the display portion.

10. The sign of claim 1, wherein, when in the open position, the first foot and second foot are configured to form an inverted V-shape relative to a surface upon which the first foot and second foot rest.

11. The sign of claim 1, wherein the first foot and second foot each comprise a flared portion.

12. The sign of claim 11, wherein the first foot and second foot are configured to move from the closed position toward the open position when the flared portion is pushed against a surface.

13. The sign of claim 1, wherein the first foot and second foot are configured to automatically move to the closed position when the sign is removed from a surface.

14. The sign of claim 1, wherein, when the first foot and second foot are in the open position, the display panel is configured to be substantially perpendicular to a surface upon which the first foot and second foot rest.

15. A sign, comprising:
a display panel;
a first foot;
a second foot; and
a connecting mechanism that connects the first foot and second foot to a lower portion of the display panel,
wherein the first foot and second foot are configured to move between a closed position and an open position, and
wherein, when in the closed position, the first foot is configured to be adjacent and substantially parallel to the display panel, and the second foot is configured to extend below and substantially parallel to the display panel.

16. The sign of claim 15, wherein the connecting mechanism includes a hinge connecting the first foot and the second foot to the display panel.

17. The sign of claim 16, wherein the hinge comprises a pin connected to a first foot or second foot; and an attachment portion.

18. The sign of claim 15, wherein the first foot and the second foot are substantially parallel to a surface upon which the first foot and second foot rest, when in the open position.

19. The sign of claim 15, wherein the first foot and second foot are substantially identical.

20. The sign of claim 15, wherein the first foot and second foot are configured to pivot relative to the display panel.

21. The sign of claim 15, further comprising a handle integral with the display portion.

22. The sign of claim 15, wherein, when the first foot and second foot are in the open position, the display panel is configured to be substantially perpendicular to a surface upon which the first foot and second foot rest.

23. The sign of claim 15, further comprising a locking unit configured to maintain the display panel substantially perpendicular to a surface.

24. The sign of claim 23, wherein the locking unit comprises a recess in the display panel and a tab on a first foot or a second foot, the tab including a protruding portion and a base.

25. The sign of claim 24, wherein the tab is configured to bend into and out of the recess.

26. The sign of claim 24, further comprising a second recess.
